(19) United States
(12) Patent Application Publication
(10) Pub. No.: US 2012/0128030 A1
(43) Pub. Date: May 24, 2012

(54) Temperature Sensor

(75) Inventors: Dieter Suess, Herzogenburg (AT); Roland Groessinger, Wien (AT)

(73) Assignee: SUESSCO KG, Herzogenburg (AT)

(21) Appl. No.: 13/387,777

(22) PCT Filed: Jul. 19, 2010
(86) PCT No.: PCT/AT10/00264

§ 371 Date: Jan. 30, 2012

(30) Foreign Application Priority Data
Jul. 29, 2009 (EP) 09450135.0

(51) Int. Cl. G01K 7/36

(52) U.S. Cl. 374/163; 374/E07.039

(57) ABSTRACT

The invention relates to a sensor for measuring temperature without contact. Both the instantaneous temperature and the rising above or falling below a critical temperature can be detected. The invention is characterized in that the sensor contains a magnetic element (for example, a magnetocaloric material and/or shape memory alloy), the magnetic characteristics of which change greatly as the temperature changes. The temperature to be measured is determined indirectly by means of a variable magnetic field (which acts, for example, on the resonator plate or another soft magnetic element).

### SUMMARY

The invention relates to a sensor for contactless measurement of temperature. Both, exceeding or undercutting a critical temperature can be detected.

The invention is characterized that the sensor comprises a magnetic element (eg: magnetocaloric material or shape memory alloy), which changes its magnetic properties strongly with temperature. Materials which show a first order phase transition are particular suitable.

The temperature will be measured indirectly via a change of a responding magnetic field when the sensor is excited by an excitation field.

The invention relates to the monitoring of temperatures and in particular a device suitable therefor according to the introductory part of claim 1.

The measurement of temperatures, in particular the detection if in a certain timeperiode the temperature was below/above a critical temperature is from great importance for many applications. The knowledge if a critical temperature was exceeded gives important information about product liability questions. For example, the temperature in tires of cars and trucks is of great importance for road safety. Another example is the statutory monitoring of food and medicine shipments, where compliance with the prescribed tolerance of the temperature must be logged. For the monitoring of the cold chain usually not the actual temperature is of interest, but the question whether the temperature of the product throughout the logistics process, was within certain bounds. For example indicators are used that permanently change their color, if the permissible maximum temperature is exceeded.

All these indicators have the disadvantage that they are poorly automatically readable. An additional problem of these systems is the complex logistics. In particular most indicators have to be shipped in the cooled state. An exception are indicators which rely on the change of color, which can be activated with UV light.

The invention has the task of solving this problem and suggests a sensor comprising of a sensor material, which exhibits at least one phase transition of first order as function of temperature, and/or consists of a magnetocaloric alloy or a shape memory alloy, and wherein the sensor material is at least in one phase magnetic and that the sensor material is magnetically soft and the sensor comprises at least a soft magnetic material having a response to an external time-varying magnetic field, and that the detection by the sensor material or soft magnetic material emitted magnetic field detected, which serves to identify the temperature.

According to one embodiment of the invention, the sensor material bases on one of the alloys: Gd₅, Gd₅(Si₁₋ₓGeₓ)₄, Ni—Mn, Ni—Mn—Ga, Ni—Mn—In—(Co), La—Fe—Si, La—Fe—Si—Co, La—Fe—Si—Co—B, La—Fe—Si—Cu, La—Fe—Si—Ga, La(Fe, Si,Co), LaFeₓSi₁₋ₓ, La(Fe,Si)₁₃, RCo₂ with R from (R═Dy,Ho, Er), DyAl₂, DyNi₂Tb—Gd—Al, Gd—Ni, Mn—As—Sb, MnFe—P—As.

Thus, for example, the sensor consist of a magnetic material which undergoes a phase transition when a critical temperature goes below or above a certain limit. This ribbon is magnetic, at least in one phase. For most technical applications of this invention phase transition of first order are from particular interest since they exhibit an abrupt change in magnetization as a function of temperature. As will be explained later in detail, the sensor characteristics of the ribbon are the better the larger the change in the magnetization as a function of temperature is.

In contrast, second-order phase transitions show a continuous change of the magnetization as a function of temperature. Example of a second order phase transition is the Curie temperature where the ferromagnetic phase transforms to the paramagnetic phase [1].

Examples of first-order phase transitions can be found both in magnetocaloric materials, as well as shape memory alloys. Thus within the scope of the invention for example these materials can be used as sensor materials.

As an example of a shape memory alloys in Ni—Mn—Ga as the temperature is increased, a change of the structure of martensite (low magnetization) to austenite (high magnetization) occurs.

In magnetocaloric materials often a first-order phase transition is observed, such as a transformation from an antiferromagnetic phase to a ferromagnetic phase. Recently, magnetocaloric materials have been (1997) proposed for the realization of magnetic refrigerators [2]. For magnetic cooling, the change of temperature during demagnetization is exploited using magnetocaloric materials. From the laws of thermodynamics, there is the connection between the change of heat ΔE a and the change of entropy ΔS, as ΔE=TΔS.

In order to realize highly efficient refrigerators, materials with high and therefore a high are need. Interestingly, one can show that magnetocaloric materials and shape memory alloys which are optimized for refrigerators have excellent properties for the proposed invention as a sensor. This can be shown by looking at the Maxwell relation, which provides a between the change of magnetization as temperature T and the change of entropy, ΔS with the external field. The Maxwell's relation gives:

$${( \frac{\partial S}{\partial H} )}_{T , P} = {( \frac{\partial M}{\partial T} )}_{H , P} .$$

ΔE and the change of entropy, ΔS as, ΔE=TΔS.

To maximize cooling, the change of magnetic entropy as function of external field has to be maximized. If this property is maximized in turn also the proper is maximized which is required for the proposed sensor, namely the change of magnetization as a function of temperature. The temperature, where a small of a change in temperature leads to a maximum change of magnetization is called the critical temperature Tc. For magnetocaloric materials and shape memory alloys this critical temperature was raised to room temperature only in recent years.

The proposed sensors can be read out wirelessly. When used as a cold chain monitoring sensors, they have the further advantage that they do not have to be delivered (in contrast to other conventional temperature indicators) in the cooled state. The sensors can be activated after having been frozen on site (eg by mechanical stresses, magnetic fields and low and high temperatures). This saves energy and costs. The sensor is a passive element that does not require a separate power supply or other electronic items.

One embodiment of the invention can contain the following essential components of the sensor:

(I) a magnetostrictive resonator, which has a resonant frequency as function of an applied magnetic field;

(ii) a magnetic bias ribbons with a phase transition of first order. Such a phase transition can be realized for example by using magneto-caloric material or shape-memory alloys, which show a significant change of the produced strayfield if the critical temperature is overcut,

(iii) an optional permanent magnet in order to set the operating point of the sensor.

The resonator consists of a magnetostrictive material that is placed in a protective cover so that the ribbon can be mechanically vibrate freely. Magnetostrictive resonators are to be used in the electronic article surveillance, see Ref [3], in libraries or in department stores.

Magnetostrictive ribbons have been used to determine temperature, pressure, pressure in fluids and proposed to be used for biological and chemical sensors, see Ref [4] and Ref [5]. A magnetostrictive element changes its length as a function of applied field. Thus, by applying a magnetic field pulse the ribbon is elongated. The field pulse can be generated for example, with a transmitting coil, which is located near the resonator. After switching off the field the resonator oscillates back. The oscillation frequency or resonance frequency is characteristic for the magnetic sensor and depends on the applied magnetic field or temperature. The mechanically vibrating resonator produced a time varying magnetic field due to the effect of magnetostriction. This magnetic field can be detected using a sensing coil remotely. The signal of the sensor can be received 1-2 m away from the magnetic field sensor.

The bias ribbon is made of a material as discussed above, a strong change in the magnetization near the critical temperature is shown. Due to the strong magnetization change also the magnetic stray field which the bias ribbon exerts on the resonator ribbon is altered. Consequently, this changes the resonance frequency of the resonator. From the change in resonant frequency one can thus tell the temperature and for a specific embodiment of the bias ribbon also a deviation above or below a critical temperature. The permanent magnet is needed to set the operating point of the sensor. Despite this practical importance the permanent magnet is not so important for the underlying concept of the invention. Both the resonator ribbon and the bias ribbon usually require some external field to show the desired functionality.

The influence of the earth's magnetic field on the signal can be compensated by the arrangement of multiple sensors.

The components of the sensor according to the invented sensor device can be of various forms, e.g. be realized as ribbon, where the term “ribbon” is used because of the obvious shape of these components used, without the necessity to really implement them in such way. The materials can be realized for example also in wire forms.

Below examples of suitable materials for the construction of an sensor according to the invention are given.

Resonator ribbon or ribbons: magnetostrictive material. Can e.g. be an amorphous ribbon. Alloys containing Fe, Co, Ni, Th, Cu, Dy, Pd, B, P, C and Gd are possible. It can also be a nanocrystalline ribbon with particle sizes between 1 nm and 1 micron, and containing Tb, Dy, Fe, Co, Ni, B, P, C, Gd, Si, B, Nb or Mo.

Permanent magnetic ribbon or ribbons: A permanent magnet which is used to set the operating point. For examples Alnico magnets, alloys based on Fe-oxide, barium/strontium carbonate, Ticonal, materials containing Sm, Ni, Co, Nd, Fe and B, respectively.

Bias ribbon or ribbons: A material with a first order phase transition, e.g. a magnetocaloric material or a shape memory alloy, whose magnetization and therefore also its or their stray field is strongly changed in the vicinity of the critical temperature.

When exceeding a critical temperature the following transitions are observed both in magnetocaloric materials as well as in shape-memory alloys:

(i) state with high magnetization to a low magnetization state

(ii) state with a low magnetization to a state with high magnetization

For magnetocaloric materials these phase transitions are often reversible. That is, after temperature comes below the critical temperature again the magnetic state of the ribbon is the same or very similar to the initial state. Such a reversible change in magnetization is suitable to realize temperature sensors for determining the current temperature with high resolution near the critical temperature. Thus, for example in the case of a clinical thermometer, a high resolution in the range of 35° C. to 42° C. can be achieved. It is possible to use magnetocaloric materials which show a sharp change of magnetization in this temperature range. The critical temperature can be for example at 45° C. However, reversible magnetization change is not suitable for the detection of a maximum/minimum temperature. Rather, for maximum/minimum temperature sensors, magnetic materials are needed which yield an irreversible change of the magnetic state when the critical temperature is exceeded, or at least show a significant thermal hysteresis, which is often found in shape memory alloys. Realization possibilities for magnetocaloric materials with irreversible magnetization curves are described in the discussion of the enclosed figures.

The term thermal hysteresis shall be illustrated by the following example. For the shape memory alloy Ni—Mn—In—Co, for example, a transition from low to high magnetization occurs when a temperature of 7° C. is exceeded. However, when re-cooling it is necessary to reach a temperature below −33° C. to change back to the state with low magnetization. In this case the thermal hysteresis is 40° C. and sufficient to detect at least a one-time increase in temperature above 7° C. permanently. Only when the sensor is cooled to −33° C., the sensor is reset to its initial state.

An example of a material that can be used in a temperature sensor for the detection of a critical maximum temperature is NiMnGa. The critical temperature where the martensitic transformation takes place, can be set in the range of 175 K to 450 K according to the chosen alloy [6]. Below the critical temperature NiMnGa exists in a tetragonal phase with for a proper choice of the grain size also shows a sufficiently large crystalline anisotropy for hard magnetic properties. In particular, a nonzero remanence can be realized if the ribbon is saturated by an external field while being activated. Thus this ribbon exerts a stray field on the resonator ribbon and thereby sets a specific resonant frequency of the resonator ribbon. If the sensor is then heated above the critical temperature, there occurs a phase transition from the tetragonal phase to a cubic phase and the average magnetization disappears. When re-cooling the tetragonal phase can indeed be reached again, but it would require a significant field during the cooling to achieve a magnetic state with a nonzero magnetization. Thus after a single exceedance of the critical temperature the average magnetization of the bias ribbon is set close to zero. As a result the bias produces no stray field and the resonant frequency of the resonator ribbon is different to the case of an saturated bias ribbon. Due to the changing of the resonant frequency, already one single heating above the critical temperature can be determined.

Instead of activating the ribbon by cooling the activation can also be accomplished by mechanical stresses.

In a further embodiment of the sensor, the phase transition of the magnetocaloric material is not detected by resonant vibrations but determined by the change in the shape of the hysteresis curve. This may for example be realized by one or more magnetocaloric or shape-memory ribbons interacting with soft magnetic elements or ribbons which show soft magnetic behavior themselves and thus indicate a sharp change in permeability with temperature.

If the magnetization of the magnetocaloric or shape memory ribbon changes also the demagnetizing factor of the surrounding soft magnetic particles or elements is changed. If, on the other hand, the magnetocaloric or shape-memory ribbons are softmagnetic themselves, the demagnetizing factor of this ribbon changes and no additional soft magnetic elements are required for the temperature detection. This change in the demagnetizing factor is reflected by a change of the hysteresis curve. The change in the shape of the hysteresis curve can be analyzed by analyzing the harmonic vibration when a non-constant alternating field is applied [7]. Here, for example by application of a sinusoidal alternating field, the magnetization of the soft magnetic elements is continuously reversed and thereby driven to saturation. As the permeability of the material in the saturation is by a few orders of magnitude smaller than in the central part of the hysteresis curve also the resulting change in magnetization and therefore the induced voltage in the receiver is no longer a pure sine wave. The harmonic content (i.e.: second harmonic oscillation) can be used to measure the saturation field, which depends on the demagnetizing factor. This allows to determine the temperature.

In a further embodiment of the sensor the sensor element can act both as a magnetocaloric element for detecting the temperature and as soft magnetic transmitter element. La(FeₓSi₁₋ₓ)₁₃ which show a colossal linear magnetostriction, is magnetocaloric and has soft magnetic properties. The critical temperature can be increased by increasing the Si concentration from 185 K (1.3% Si) to 250 K (2.5% Si). Thus a sensor for different application temperatures can be developed. Mechanical vibration can be excited in the La(FeₓSi₁₋ₓ)₁₃ element by a periodic magnetic field. After switching off the field the element continues oscillating for up to several milliseconds and emits a magnetic field due to the Villari effect. As the magnetic properties strongly change in the vicinity of the critical temperature also the resonant frequency heavily changes as a function of the temperature due to the ΔE-effect. Thus, a La(FeₓSi₁₋ₓ)₁₃ ribbon can be used as a temperature sensor with high accuracy near the critical temperature. An example of us a wireless device for determining the body temperature of humans or animals may be mentioned. To set the operating point of the sensor for most sensor applications an additional element is needed which creates a magnetic bias field. Instead of the magnetocaloric element La(FeₓSi₁₋ₓ)₁₃ for example also the shape memory alloy Ni—Mn—In—Co can be used.

The invention is described below with reference to exemplary embodiments illustrated in the drawings in more detail.

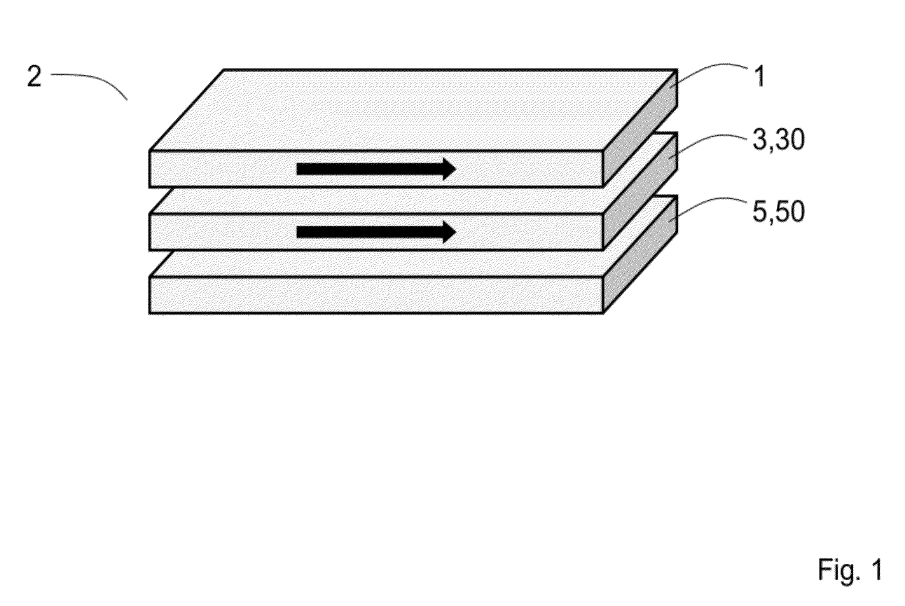

FIG. 1 is a schematic oblique plan view of a sensor of an embodiment below the critical temperature;

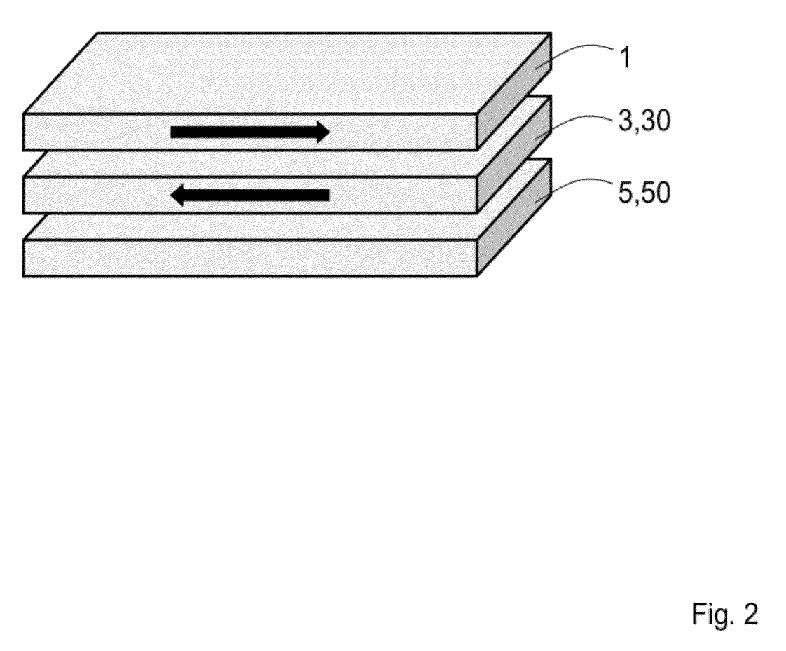

FIG. 2 shows the sensor according to FIG. 1 above the critical temperature;

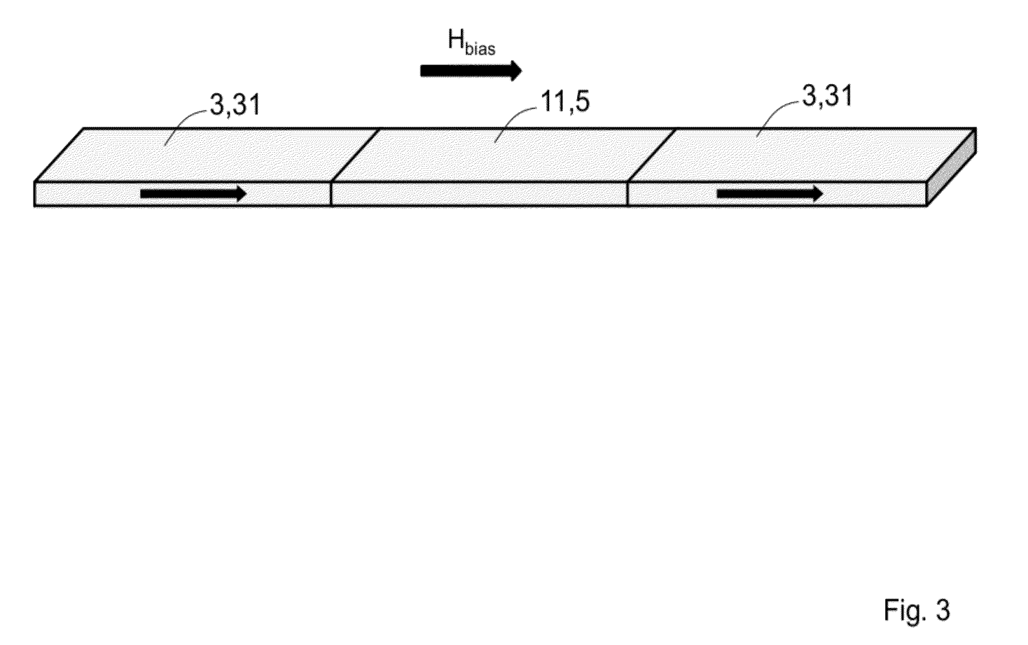

FIG. 3 is a schematic oblique plan view of a sensor to a further embodiment of the invention below the critical temperature;

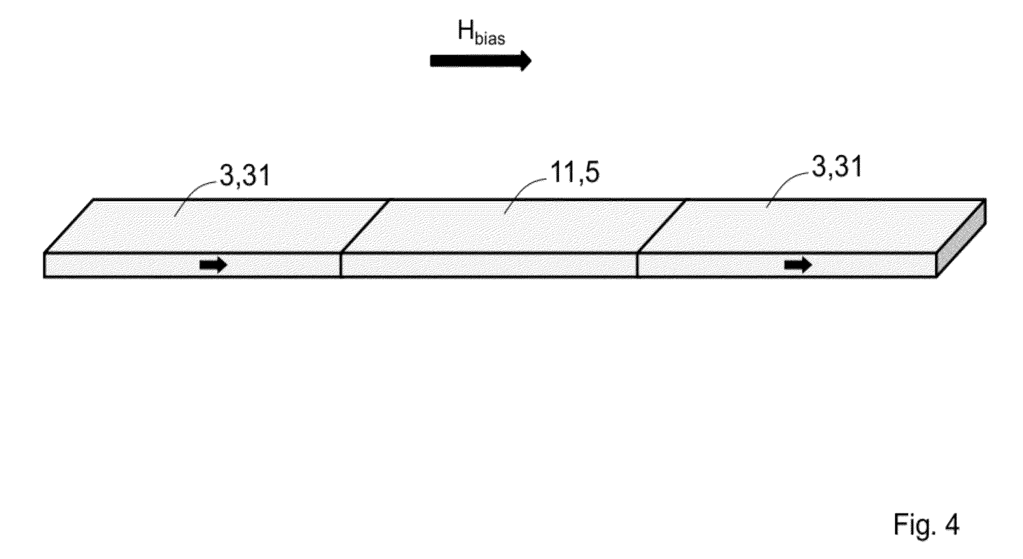

FIG. 4 shows the sensor according to FIG. 3 above the critical temperature;

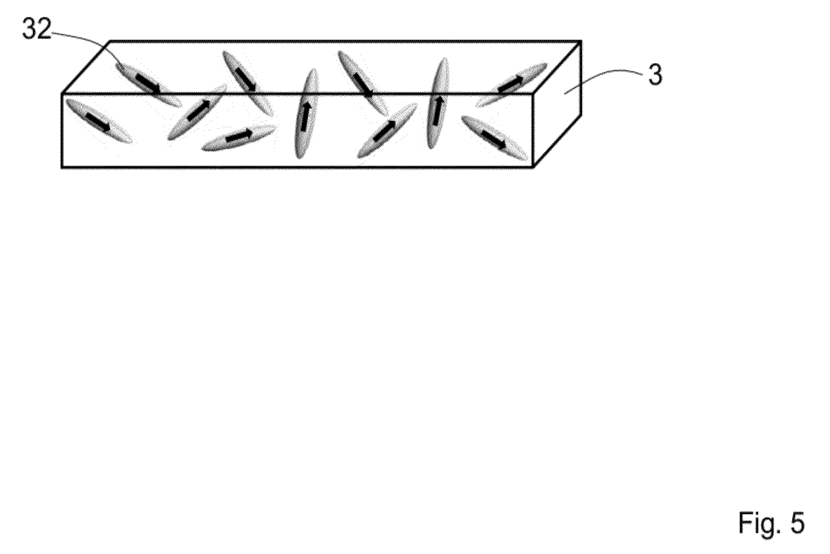

FIG. 5 is a schematic oblique plan view of a sensor to a further embodiment of the invention below the critical temperature;

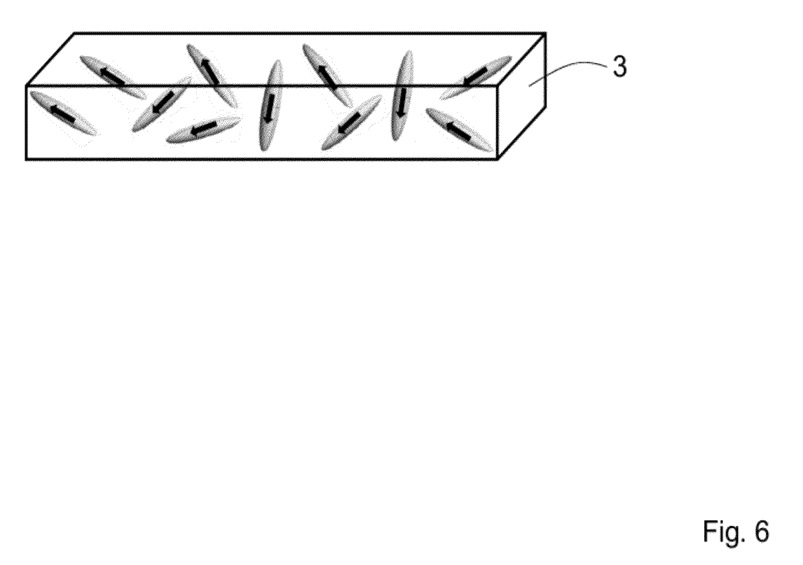

FIG. 6 shows the sensor according to FIG. 5 above the critical temperature;

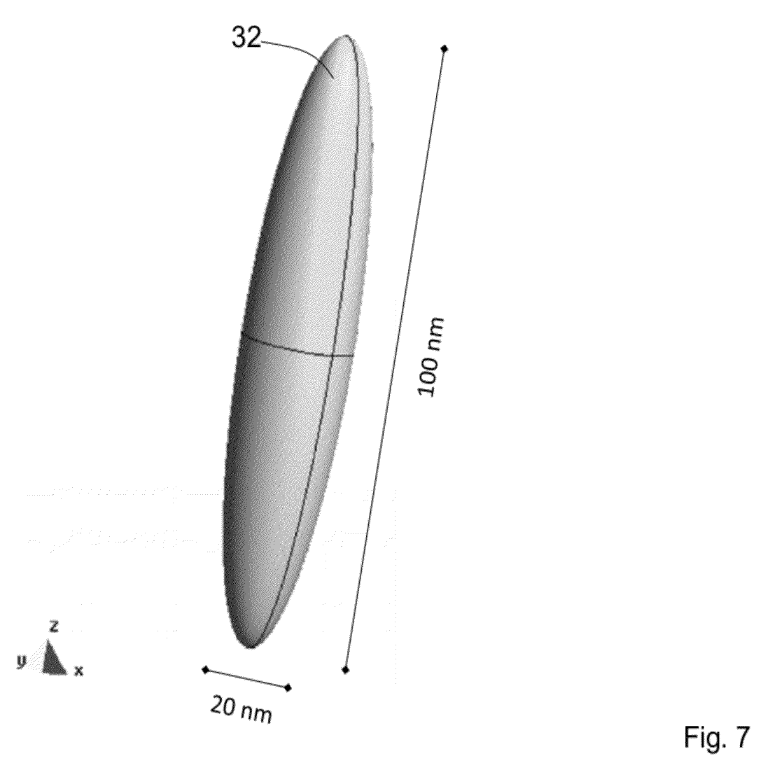

FIG. 7 shows an enlarged representation of a particle of the magnetocaloric material, which finds application in the sensor according to FIG. 6;

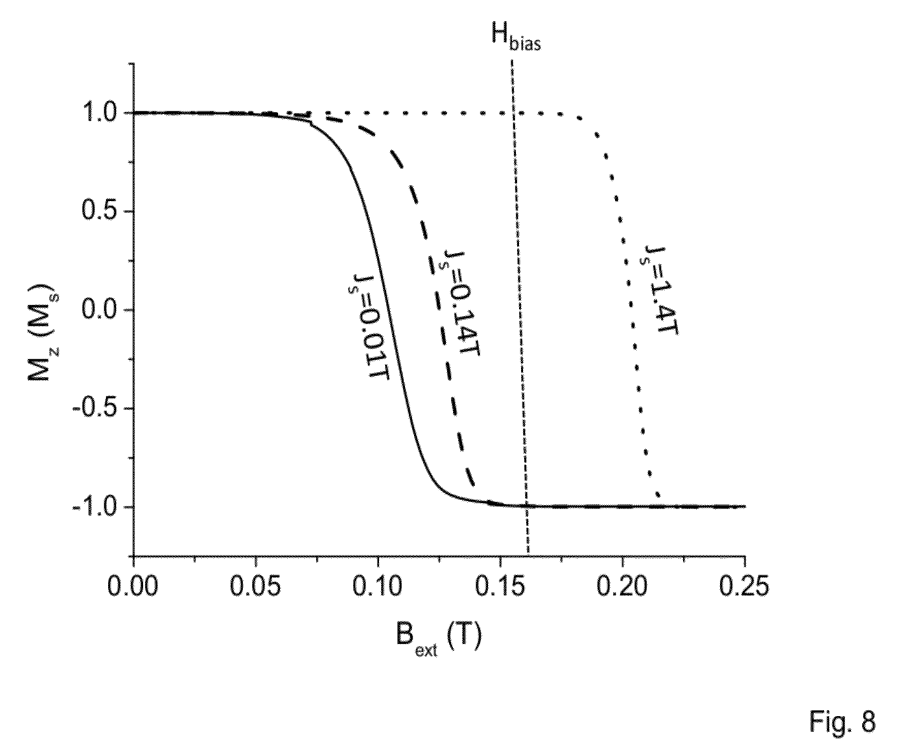

FIG. 8 shows a hysteresis loops for particles from FIG. 7;

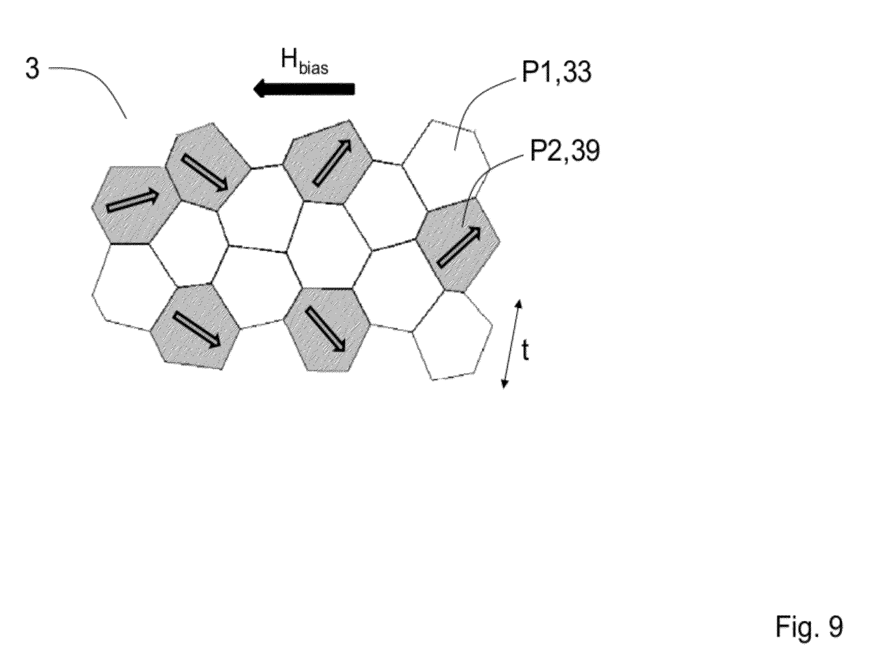

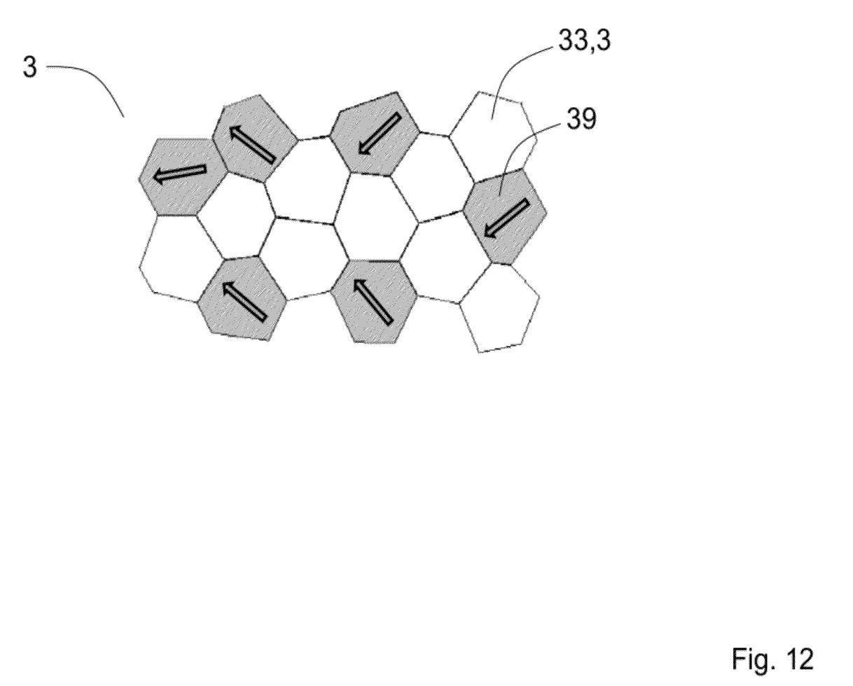

FIGS. 9 and 12 show a schematic representation of a sensor to a further embodiment of the invention in different states; realization of irreversible magnetization process of using nanocrystalline materials;

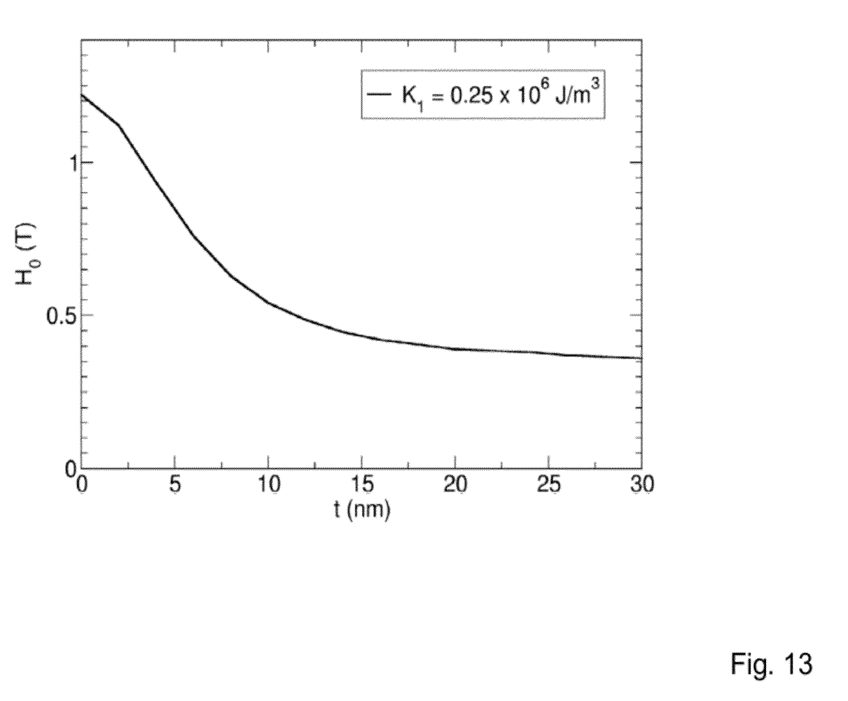

FIG. 13 shows a diagram which shows the reduction of the switching field as a function of size (grain diameter=t) of the soft magnetic inclusions;

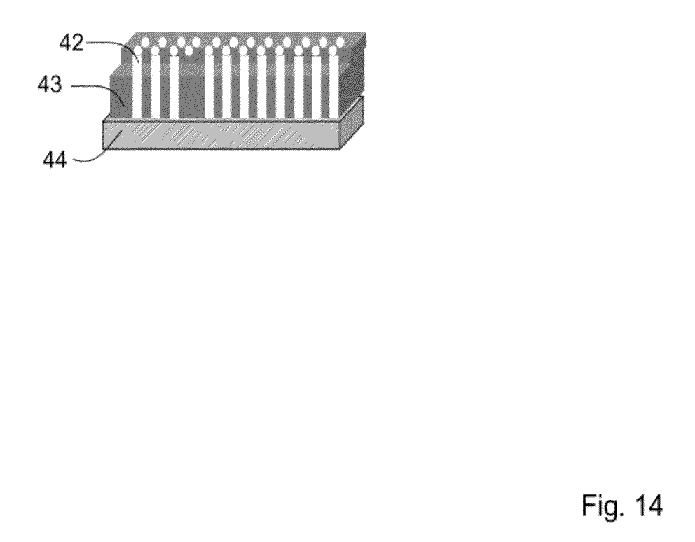

FIG. 14 shows a schematic oblique view of a sensor material of another embodiment of the invention in the form of patterned films for the production of magnetocaloric materials with shape anisotropy;

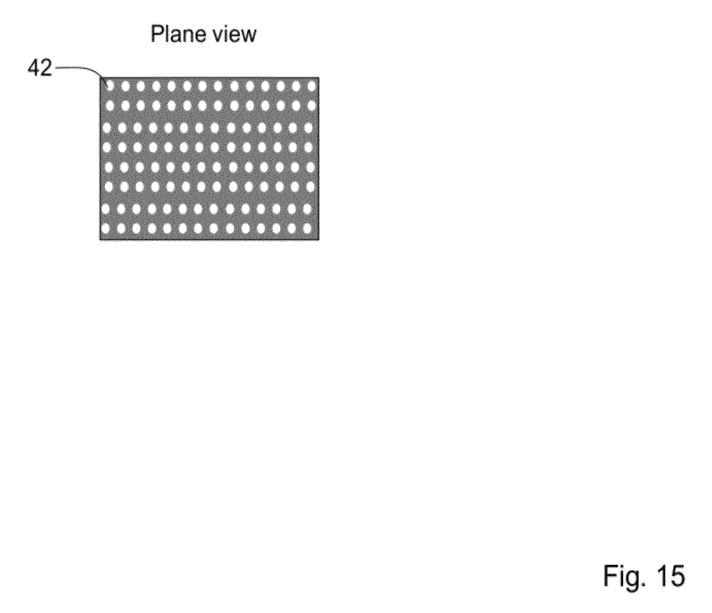

FIG. 15 shows a top view of FIG. 14

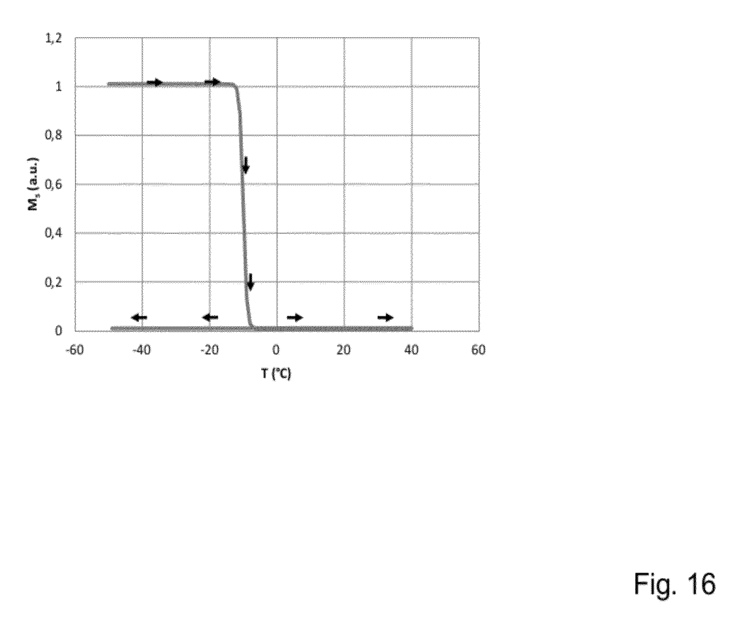

FIG. 16 shows a diagram of magnetization as a function of temperature, from which the irreversible transition from nonmagnetic to magnetic be seen at the critical temperature.

FIG. 1 and FIG. 2 show an embodiment of a sensor device according to the invention with a sensor 2, which is embedded in a not illustrated case or housing and formed by three plane-parallel ribbons 1, 30, 50, where one of the ribbons is a permanent magnet 1, which produces a static magnetic field and is necessary for setting the operating point of the sensor 2. Another ribbon is a resonator ribbon 50 of a soft magnetic material 5 which is in the illustrated embodiment realized by a magnetostrictive ribbon (Fe₂₄Co₁₂N₄₆Si₂B₁₆), whose mechanical resonant frequency depends on the ambient conditions such as external magnetic fields.

Furthermore, the third ribbon is a bias ribbon (Ni₄₅Mn_{36.7}In_{13.3}Co₅) 30 of a sensor material 3, which consists of a magnetocaloric alloy and/or a shape memory alloy, which show a phase transition of first order at a critical temperature.

The bias ribbon 30 may consist of a different sensor material that undergoes a phase transition of first order at critical temperature.

The sensor device according to the invention includes in addition to sensor 2, a device which is not illustrated to produce a time varying magnetic field in the sensor 2, e.g. a transmitter coil, and a not illustrated detector, for example a receiver coil, which is suitable for detecting the magnetic field which is emitted by sensor 2.

As a response to the externally applied time-varying magnetic field, the soft magnetic material of resonator ribbon 50 shows a periodically varying magnetization, which is detected by the detector to identify the temperature.

The connection between the individual ribbons 1, 30, 50 is not shown, the resonator ribbon 50 should be arranged as loosely as possible or be clamped in a way that does not or marginally constrain the deformations which are induced by the magnetic field. The respective actual arrangement of the ribbons 1, 30 and 50 may differ from the one shown in FIG. 1. Thus, for example the ribbons 1, 30 and 50 may be arranged interchanged.

The not illustrated protection case into which the sensor 2 is embedded may consist of various materials. Embedding in a magnetic material can show the advantage that the Earth's magnetic field is reduced in the interior, however, the sensor signals are also attenuated. Plastics such as thermoplastics, thermosets, elastomers are particularly preferred. For high temperature applications fireproof ceramics such as compounds of silicate raw materials, compounds on the basis of magnesite, silicon oxides, aluminum oxide, silicon carbide, boron nitride, zirconia, silicon nitride, aluminum nitride, tungsten carbide and aluminum titanate are used.

The sensor 2 can be provided as irreversible sensor (to determine comes below or exceeds critical temperatures) as well as a reversible temperature sensor (measuring the current temperature).

If it is intended to display the exceeding or undercut of a critical temperature, an irreversible change of the magnetization in the bias ribbon 30 must take place after exceeding/falling below the critical temperature. Thus, after the exceeding/undercut due to changed magnetic state the bias ribbon 30 creates a different magnetic field which acts on the soft magnetic material of the resonator ribbon 50. Thus, the resonant frequency of the resonator ribbon 50 changes which serves to identify an excess/undercut of the critical temperature. The changed magnetization of the bias ribbon 30 that occurred after exceeding the critical temperature is shown schematically in FIG. 2.

On the other hand, the sensor 2 can also be used to measure the current temperature. In this case a magnetocaloric material is used as bias ribbon 30 that changes its magnetization reversibly when exceeding/falling below the critical temperature (La_{0.925}Na_{0.075}MnO₃).

Due to the strong change in the magnetization near the critical temperature, the sensor device according to the invention shows a high accuracy in this temperature range. If the magnetocaloric La(FeₓSi₁₋ₓ)₁₃ is used as sensor material, the additional soft magnetic element can be replaced because La(FeₓSi₁₋ₓ)₁₃ itself is magnetically soft and has a large magnetostriction.

FIG. 3, 4 show another embodiment of the sensor device according to the invention that measures the temperature. In this case the sensor device according to the invention contains no mechanical vibrating element.

To an element of a soft magnetic material 5, which is realized as ribbon 11, ribbon-shaped elements 31 of a magnetocaloric sensor material 3 or a sensor material with a first order phase transition (La_{0.65}Nd_{0.05}Ca_{0.30}MnO) are added to each end which form the sensor 2.

If now below the critical temperature an alternating magnetic field along the longitudinal direction of the sensor 2′ is applied, the latter can be easily magnetized because the sensor 2′ has only a small demagnetizing field (FIG. 3).

When increasing the temperature the magnetocaloric sensor material 3 of the element 31 loses its magnetization (FIG. 4) or it is strongly reduced. This increases the demagnetizing factor of the soft magnetic element 11 and it will need larger fields to magnetize the sensor 2′. Through analysis of harmonics (e.g. the second harmonic oscillation), the change of the demagnetizing factor can be determined. This allows to deduce the temperature.

FIGS. 5 and 6 show an embodiment of the invention, wherein for the sensor material 3 a magnetocaloric material with particles 32 is used to achieve an irreversible change in the stray field when exceeding/falling below a critical temperature.

Below the critical temperature all particles 32 of the sensor material 3 are saturated to the right. This state is also stable as each particle 32 has a shape anisotropy. One such particle is shown in FIG. 7 in detail. The aspect ratio is 100:20. The hysteresis curve for such a particle is shown as a function of the saturation magnetization in FIG. 8. For the described example of an embodiment it is assumed that the magnetization of the magnetocaloric sensor material 3 at low temperatures (<−6° C.) is J=1.14 Tesla. The particles 32 has a considerable anisotropy for this magnetization. As a result the particle 32 has a relatively high coercive field of 0.2 Tesla. Now, if the sensor material 3 is heated the magnetization decreases. At a magnetization of 0.01 T the coercive field is 0.1 Tesla only. A bias field H_{Bias} of 0.16 Tesla can thus remagnetize the particles 32 in the heated state. Thus, an irreversible change in the magnetization in the magnetocaloric sensor material 3 occurred. Such a material is for example suitable for the detection of exceeding of a critical temperature.

FIGS. 9 to 12 show another way to realize irreversible magnetization states in the sensor material 3 in a sensor device according to the invention.

For an application sensor material 3 shown in FIGS. 9 to 12 would be combined with other elements such as shown in FIGS. 1 and 2, e.g. with a resonant ribbon and a permanent magnet to enable a temperature detection.

Magnetocaloric grains 33 (p1) are exchange coupled with hard magnetic grains 39 (p2). Initially, the hard magnetic grains 39 are aligned to the right. A bias field is applied to the left, which is not large enough to reverse the magnetization of the hard magnetic grains. At low temperatures the magnetocaloric material 3 has no magnetization.

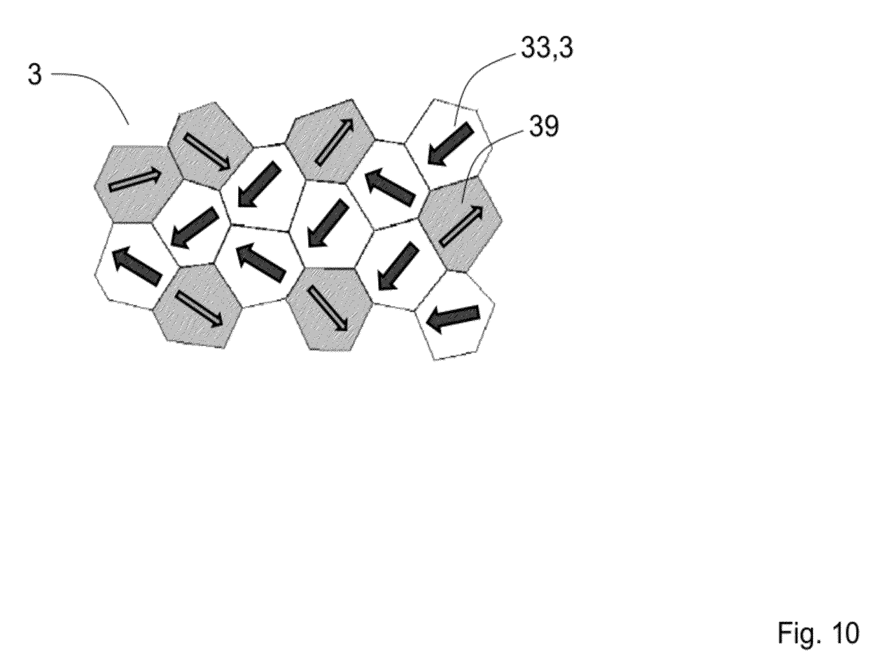

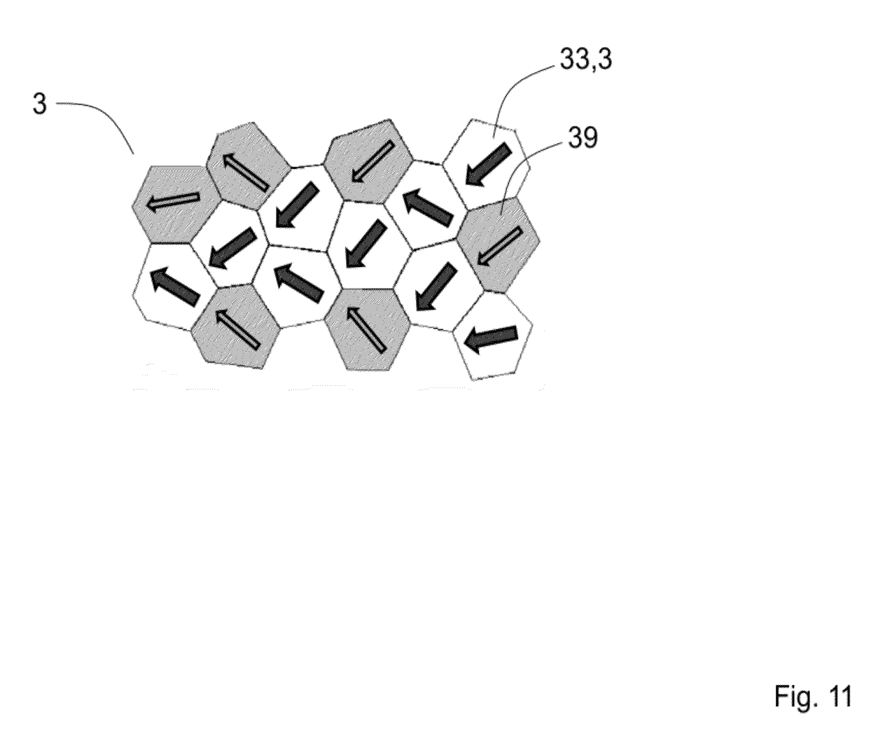

Now, if the sensor is heated the magnetization of the magnetocaloric material 3 increases (FIG. 10). The magnetization of the magnetocaloric grains 33 acts as a lever on the hard magnetic grains 39 and supports the magnetization of the grains [8]. The bias field can use the magnetocaloric material 3 to reverse the magnetization of the hard magnetic grains 39 (FIG. 11). Even when decreasing the temperature the initial magnetic state is not restored (FIG. 12). This material is suitable for the detection of a maximum temperature, too. FIG. 13 shows the required switching field of hard magnetic grains 39 if they are exchange coupled to magnetocaloric grains 33 with a diameter (t). It shows that the coercive field is reduced by a factor of 4 when the magnetocaloric grains 33 (p1) have a diameter of t>20 nm.

FIG. 14 and FIG. 15 show an embodiment of the sensor device according to the invention where magnetocaloric material with a shape anisotropy are used. The shape anisotropy is realized by the elongated shape of the holes, where the cylinder diameter is much smaller than the cylinder height. On a silicon substrate 44 aluminum 43 is deposited, which is anodized which leads to the formation of holes 42 with different diameters and densities [9]. These holes 42 can be filled in a second step with a magnetocaloric material.

FIG. 16 shows schematically the irreversible change of the saturation magnetization as a function of temperature. In the example the magnetic state of the shape memory alloy transforms from martensite (ferromagnetic) to austenite (not ferromagnetic). The two open branches of the magnetization at low temperatures can remain open (irreversible) or closed (thermal hysteresis). The irreversible behavior of the saturation magnetization shows that shape-memory alloys can be used as sensor material 3 to detect if a critical temperature was exceeded.

The invention is not limited to the illustrated and described embodiments but can be modified in various ways. It is essential that the temperature measurement is attributed to a sharp change of magnetization. The sensor does not require any power supply and the energy required for the measurement process as well as the measurement result, as described above, is transmitted without contact.

There are also different combinations of the elements shown and described possible. In the future also new materials processing methods may be possible. The reason for this explicit statement, is that in the area of material science there is rapid development occurs and the particular alloys mentioned do not limit the claimed protection.

### LITERATURE

[1] “StateMaster—Encyclopedia: Curie temperature, http://www.statemaster.com/encyclopedia/Curie-temperature.”

[2] C. Zimm, A. Jastrab, A. Sternberg, V. Pecharsky, K. GSCHNEIDNER, M. Osborne, and I. Anderson, “Description and performance of a near-room temperature magnetic refrigerator,” Advances in cryogenic engineering, vol. 43, 1998, pp. 1759-1766.

[3] G. Herzer, “Der groβe Lauschangriff auf Ladendiebe,” Physikalische Blaetter, vol. 57, 2001, pp. 43-48.

[4] K. Zeng and C. A. Grimes, “Wireless Magnetoelastic Physical, Chemical, and Biological Sensors,” IEEE Transactions on Magnetics, vol. 43, 2007, pp. 2358-2363.

[5] D. Walker, “Magnetoacoustic sensor system and associated method for sensing environmental conditions,” U.S. Patent WO 03091679 A1, Nov. 6, 2003.

[6] Y. Ma, S. Awaji, K. Watanabe, M. Matsumoto, and N. Kobayashi, “Effect of high magnetic field on the two-step martensitic-phase transition in NiMnGa,” Applied Physics Letters, vol. 76, 2000, p. 37.

[7] R. Fletcher and N. Gershenfeld, “Wireless monitoring of temperature,” U.S. Pat. No. 6,208,253, Mar. 27, 2001.

[8] D. Suess, T. Schrefl, S. Fahler, M. Kirschner, G. Hrkac, F. Dorfbauer, and J. Fidler, “Exchange spring media for perpendicular recording,” Applied Physics Letters, vol. 87, July 2005, pp. 012504-3.

[9] M. T. Rahman, N. N. Shams, Y. C. Wu, C. H. Lai, and D. Suess, “Magnetic multilayers on porous anodized alumina for percolated perpendicular media,” Applied Physics Letters, vol. 91, 2007, p. 132505.

1. Sensor device with a sensor (2) to determine a temperature change within a temperature range and a detector, wherein the sensor (2) contains a sensor material (3) which comprises a first-order phase transition within this temperature range, wherein the sensor material (3) is at least in one phase magnetic, and the sensor contains a soft-magnetic material (5), which shows a periodically varying magnetization as a response to an periodically external time-varying magnetic field, and that the detector detects the emitted magnetic field from the soft-magnetic material, which is used to identify the temperature.

2. Sensor according to claim 1, where the sensor material (3) comprises a shape-memory alloy.

3. Sensor according to claim 1, where the sensor material (3) comprises a magneto caloric material.

4. Sensor according to claim 1, wherein the sensor material (3) is formed as magnetic ribbon (30).

5. Sensor according to claim 1, wherein the soft magnetic material (5) is magnetostrictive, which interacts with the sensor material (3) and a change in the magnetization of the sensor material (3) due to a change in temperature, changes the mechanical resonance frequency of the magnetostrictive magnetic material (5) and the resonance frequency is used to determine the temperature.

6. Sensor according to claim 2, wherein the soft magnetic material (5) is magnetostrictive, which interacts with the sensor material (3) and a change in the magnetization of the sensor material (3) due to a change in temperature, changes the mechanical resonance frequency of the magnetostrictive magnetic material (5) and the resonance frequency is used to determine the temperature.

7. Sensor according to claim 3, wherein the soft magnetic material (5) is magnetostrictive, which interacts with the sensor material (3) and a change in the magnetization of the sensor material (3) due to a change in temperature, changes the mechanical resonance frequency of the magnetostrictive magnetic material (5) and the resonance frequency is used to determine the temperature.

8. Sensor according to claim 1, wherein the sensor material (3) magnetically interacts with a soft magnetic element (11) and with the temperature-induced phase transition the demagnetizing factor changes of the soft magnetic element, and this serves to identify the temperature.

9. Sensor according to claim 8, wherein the soft magnetic element (11) is formed as a ribbon, and to its front faces a the sensor material (3) in the form of a ribbon-shaped element (31) is attached, and with temperature-induced phase transition of the two ribbon-like elements (31) the harmonic response of the soft magnetic element (11) of the sensor (2) is detectable.

10. Sensor according to claim 1, wherein the temperature-induced phase transition in the sensor material (3) is from paramagnetic to ferromagnetic.

11. Sensor according to claim 1, wherein the temperature-induced phase transition in the sensor material (3) is from antiferromagnetic to ferromagnetic.

12. Sensor according to claim 1, wherein the temperature-induced phase transition in the sensor material (3) is from non magnetic to ferromagnetic.

13. Sensor according to claim 1, characterized that a phase transition in the sensor material (3) is induced by mechanical stress and thus the sensor (2) can be activated.

14. Sensor according to claim 1, characterized in that at the critical temperature in the sensor material (3) induces a transition from austenite to martensite.

15. Sensor according to claim 1, wherein the sensor material (3) exhibits a thermal hysteresis, which is larger than 1° C.

16. Sensor according to claim 1, wherein the sensor material (3) exhibits a maximum change of entropy of the sensor material (3) which is larger than) |ΔSₘ|>0.01 (J/kg K).

17. Sensor according to claim 1, characterized in that when the critical temperature is exceeded irreversible magnetic changes in the sensor material (3) occure.

18. Sensor device according to claim 17, characterized in that the irreversible change in magnetization of the sensor material (3) changes the resonance frequency of the mechanically oscillating, magnetostrictive ribbon (50), which is used to identify the temperature.

19. Sensor according to claim 1, wherein the sensor material (3) comprises magnetic particles (32) having a shape anisotropy, which lead to a non-zero remanence (Mr), with Mr>0.01 Ms (Ms is the saturation magnetization).

20. Sensor according to claim 1, wherein the sensor material (3) comprises hard magnetic particles which are exchange coupled to soft magnetic particles.

21. Sensor according to claim 1, wherein the sensor material (3) has in at least one phase hard magnetic properties, and Mr>0.01 Ms.

22. Sensor according to claim 1, wherein the sensor material (3) consists of nanocomposites materials, which have a mean particle volume range from 1 nm³ to 10 μm³.

23. Sensor according to claim 1, wherein the sensor material bases on at least one of the following alloys: Gd₅(Si₁₋ₓGeₓ)₄, Ni—Mn, Ni—Mn—Ga, Ni—Mn—In, Ni—Mn—In—(Co), La—Fe—Si, La—Fe—Si—Co, La—Fe—Si—Co—B, La—Fe—Si—Cu, La—Fe—Si—Ga, La(Fe, Si,Co), LaFeₓSi₁₋ₓ, La(Fe,Si)₁₃, RCo₂ mit R aus (R═Dy,Ho, Er), DyAl₂, DyNi₂Tb—Gd—Al, Gd—Ni, Mn—As—Sb, MnFe—P—As, Gd, Mn, La, Co, Er, Fe, Nd, or contains Ni—Mn—In—Co particles or Ni—Mn—Ga particles.
